(19) United States
(12) Patent Application Publication
(10) Pub. No.: US 2013/0194906 A1
(43) Pub. Date: Aug. 1, 2013

(54) OPTICAL PICKUP AND OPTICAL SYSTEM INCLUDING THE SAME

(71) Applicants: Ji-sun Ahn, Seoul (KR); Ui-yol Kim, Suwon-si (KR); Yong-jae Lee, Suwon-si (KR)

(72) Inventors: Ji-sun Ahn, Seoul (KR); Ui-yol Kim, Suwon-si (KR); Yong-jae Lee, Suwon-si (KR)

(73) Assignee: Toshiba Samsung Storage Technology Korea Corporation, Suwon-si (KR)

(21) Appl. No.: 13/756,660

(22) Filed: Feb. 1, 2013

(30) Foreign Application Priority Data
Feb. 1, 2012 (KR) 10-2012-0010504

(51) Int. Cl. G11B 7/125

(52) U.S. Cl. CPC G11B 7/125
USPC 369/112.24

(57) ABSTRACT

Provided are an optical pickup and an optical system employing the optical pickup. The optical pickup includes a twin light source. In various aspects, a length between the two light sources of a twin light source is reduced while the magnification of the optical pickup is increased, in comparison to a conventional optical pickup. Accordingly, a manufacturing cost of the optical pickup may be reduced.

### CROSS-REFERENCE TO RELATED APPLICATION(S)

This application claims the benefit under 35 USC §119(a) of Korean Patent Application No. 10-2012-0010504, filed on Feb. 1, 2012, in the Korean Intellectual Property Office, the entire disclosure of which is incorporated herein by reference for all purposes.

### BACKGROUND

1. Field

The following description relates to an optical pickup using a twin light source and an optical system including the same.

2. Description of Related Art

In general, an optical pickup that is compatible with a digital versatile disc (DVD) and a compact disc (CD) uses a light source module such as a twin laser diode (TWIN-LD). The light source module typically includes two light sources (two semiconductor LD chips) that emit light that have different wavelengths for a DVD and a CD and which are integrated into one package.

If a pattern of a light-receiving unit of a photodetector is designed based on a distance between two light-emitting points of a twin light source, a magnification of the light-receiving unit may be affected. For example, the magnification of the light-receiving unit may be determined by a focal distance of an objective lens, a focal distance of a collimating lens or a detecting lens, a distance of the light-receiving unit, and the like, and thus may be affected by the distance between two light emitting points.

In a general optical pickup, a distance between two light-emitting points of a twin light source is usually 110 μm. Such a twin light source is used to adjust light-receiving magnification through a focal distance of a collimating lens and that of a detecting lens. Accordingly, pattern positions of the two light-receiving units are designed to drive an optical pickup.

If the twin light source is formed to have a shorter distance between the two light-emitting points, manufacturing costs of the twin light source and the optical pickup using the same may be lowered.

### SUMMARY

In an aspect, there is provided an optical pickup including a light source which emits light, an objective lens which condenses incident light to form an optical spot on an information storage medium, a collimating lens which collimates the light emitted from the light source to allow the light to be incident onto the objective lens, a photodetector which receives light reflected from the optical information storage medium to detect an information signal and/or an error signal, and a detecting lens which forms the reflected light as an optical spot on the photodetector, wherein the light source, the collimating lens, and the detecting lens are arranged such that the optical pickup has a light-receiving magnification of 9.1 times or more.

The collimating lens may be positioned between the objective lens and the light source.

The light source may comprise a twin light source that includes first and second light sources that emit first and second lights, respectively.

A distance between light-emitting points of the first and second light sources may be less than 110 μm.

A distance between the light-emitting points of the first and second light sources may be approximately 90 μm.

The optical pickup may further comprise an optical path changer which changes an optical path of the incident light emitted from the light source.

The light source may comprise a twin light source, a distance between the two light-emitting points of the twin light source may be less than 110 μm, and the detecting lens may comprise a cylindrical surface and a spherical surface which are used to generate the light magnification of 9.1 times or more.

The light source may comprise a twin light source, a distance between the two light-emitting points of the twin light source may be less than 110 μm, and a distance between the detecting lens and the collimating lens may be used to generate the light magnification of 9.1 times or more.

The light-receiving magnification may be defined as a value that is obtained by dividing a sum of a focal distance of the collimating lens and a focal distance of the detecting lens divided by a focal distance of the objective lens.

The photodetector may comprises first and second light-receiving patterns which receive the first and second lights, respectively, and a distance between the first and second light-receiving patterns may be at least 5 μm.

The first light source may emit a first light having a red wavelength for a digital versatile disc (DVD), and the second light source may emit a second light having an infrared wavelength for a compact disc (CD).

In an aspect, there is provided an optical pickup including a twin light source comprising first and second light sources which emit first and second lights, respectively, an objective lens which condenses incident light to form an optical spot on an information storage medium, a collimating lens which collimates first and second lights emitted from the twin light source to allow the incident light onto the objective lens, a photodetector which comprises first and second light-receiving patterns to receive first and second lights reflected from the information storage medium to detect an information signal and/or an error signal, a detecting lens which forms the reflected first and second lights as an optical spot on the photodetector, wherein a distance between light-emitting points of first and second light sources of the twin light source is shorter than 110 μm, and the detecting lens increases a light-receiving magnification in order to secure a gap between the first and second light-receiving patterns detecting the first and second lights of at least 5 μm.

The distance between the light-emitting points of first and second light sources of the twin light source may be approximately 90 μm.

The first light source may emit first light having a red wavelength for a DVD, and the second light source may emit second light having an infrared wavelength for a CD.

The optical pickup may further comprise an optical path changer which changes an optical path of the incident light emitted from the twin light source.

An optical information storage medium system including the optical pickup configured to move in a radial direction of an information storage medium to reproduce information from and/or record information to the information storage medium, the optical pickup comprising a twin light source, a collimating lens, and a detecting lens which are arranged such that the optical pickup has a light-receiving magnification of 9.1 times or more, and a controller configured to control the optical pickup.

A distance between light-emitting points of the twin light source may be less than 110 μm.

A distance between the light-emitting points of the twin light source may be approximately 90 μm.

The photodetector may comprise first and second light-receiving patterns which receive the first and second lights, respectively, and a distance between the first and second light-receiving patterns may be at least 5 μm.

Throughout the drawings and the detailed description, unless otherwise described, the same drawing reference numerals will be understood to refer to the same elements, features, and structures. The relative size and depiction of these elements may be exaggerated for clarity, illustration, and convenience.

### BRIEF DESCRIPTION OF THE DRAWINGS

FIG. 1 is a diagram illustrating an example of an optical structure of an optical pickup.

FIG. 2 is a diagram illustrating an example of the optical pickup of FIG. 1.

FIG. 3 is a diagram illustrating an example of a shrink-type twin light source used as a light source of an optical pickup.

FIG. 4 is a diagram illustrating an example of arrangements of first and second light-receiving patterns of a photodetector.

FIG. 5 is a diagram illustrating an example of a general twin light source.

FIG. 6A is a diagram illustrating an example of arrangements of first and second light-receiving patterns of a photodetector of an optical pickup including a general twin light source.

FIG. 6B is a diagram illustrating an example of arrangements of first and second light-receiving patterns of a photodetector when a shrink-type twin light source is included as a light source in an optical pickup.

FIG. 7 is a diagram illustrating an example of a focal distance of a light-receiving unit.

FIG. 8 is a diagram illustrating an example of an optical system including an optical pickup described herein.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

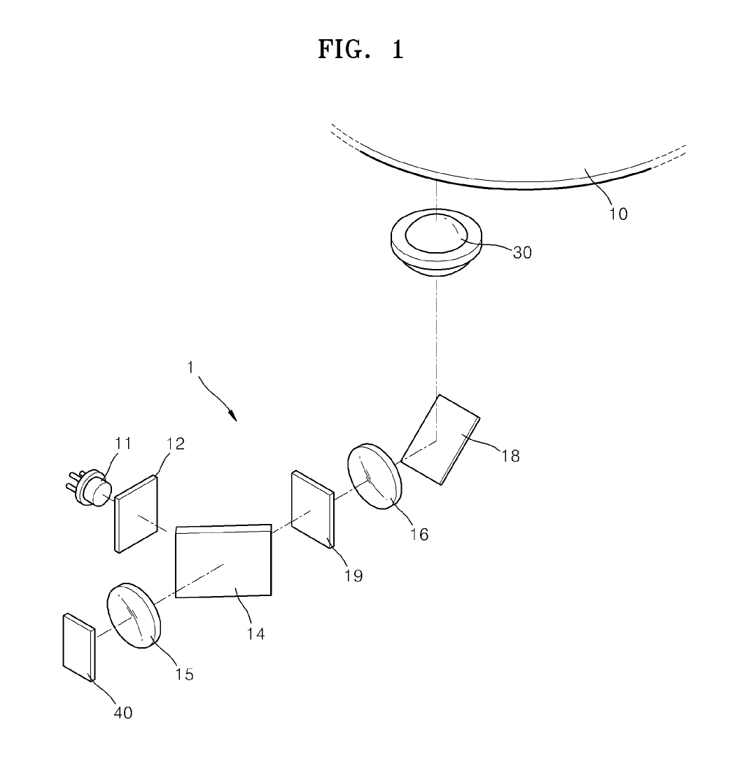

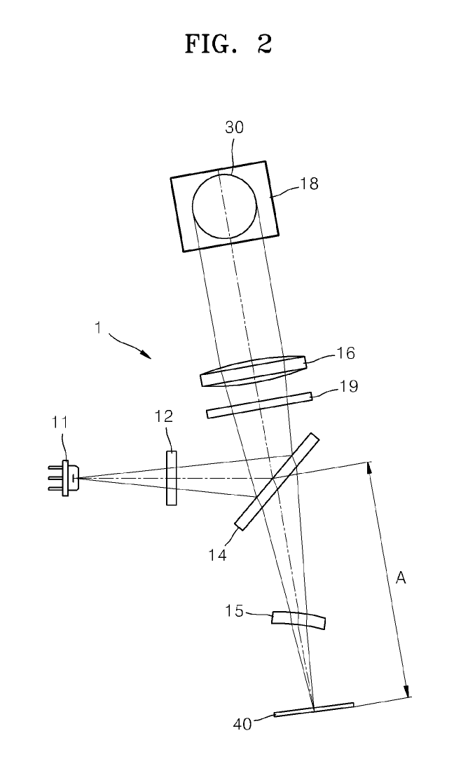

FIG. 1 illustrates an example of an optical structure of an optical pickup 1, and FIG. 2 illustrates an example of the optical pickup 1 of FIG. 1. In FIG. 2, the letter A represents a length of a light-receiving unit.

Referring to FIGS. 1 and 2, the optical pickup 1 includes a light source 11, an objective lens 30, a collimating lens 16, an optical path changer 14, a photodetector 40, and a detecting lens 15. The objective lens 30 may condense incident light to form an optical spot on optical information storage medium 10. The collimating lens 16 may collimate light that is emitted from the light source 11 to allow the light to be incident onto the objective lens 30. The optical path changer may change an optical path of an incident light beam. The photodetector 40 may receive light reflected from the storage medium 10 to detect an information signal and/or an error signal. The detecting lens 15 may allow the photodetector 40 to receive the light reflected from the optical storage medium 10 as the optical spot. For example, the collimating lens 16 may be positioned between the object lens 30 and the optical path changer.

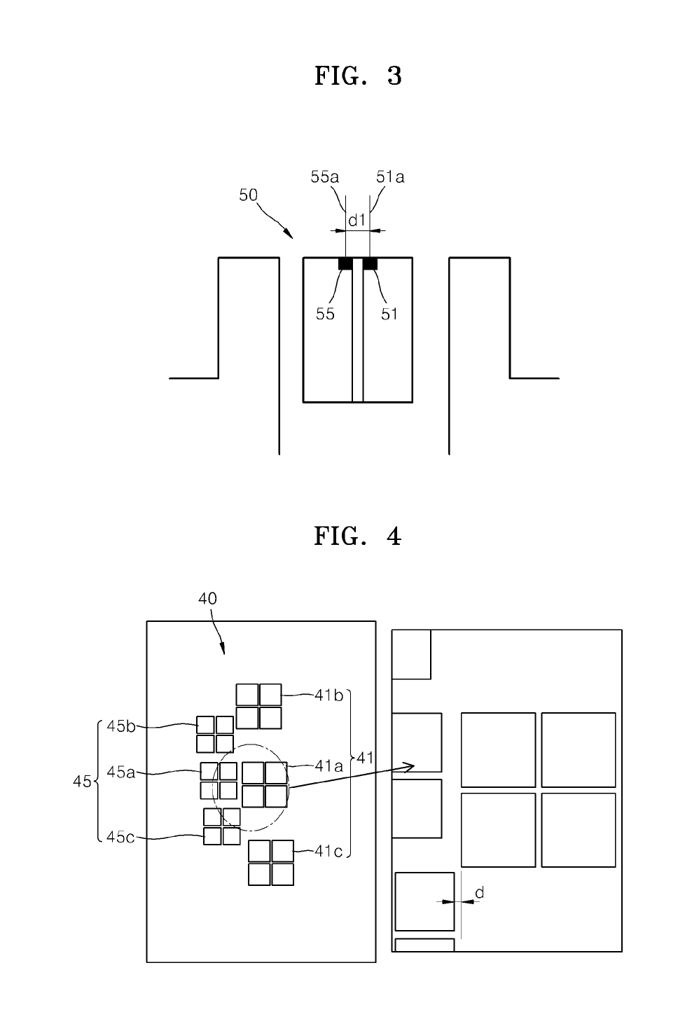

For example, the light source 11 may be a twin light source in which first and second light sources 51 and 55 emit first and second lights 55a (as shown in FIG. 3). According to various aspects, the first and second light source 51 and 55 may be installed so that a gap between light-emitting points of the first and second light sources 51 and 55 is less than 110 μm. Accordingly, the twin light source included as the light source 11 may be a shrink-type twin laser diode (TWIN-LD) 50 in which a gap between two light-emitting points is less than 110 μm. For example, the gap between the light-emitting points may be about 90 μm. When the gap between the light-emitting points is reduced, manufacturing cost of the shrink type TWIN-LD 50 may be lowered.

To enable the optical pickup 1 to be compatible with a digital versatile disc (DVD) and a compact disc (CD), for example, the shrink-type twin light source 50 may be installed so that the first light source 51 emits the first light 51a having a red wavelength appropriate for the DVD, e.g., a wavelength of about 650 nm, and the second light source 55 emits the second light 55a having an infrared wavelength appropriate for the CD, e.g., a wavelength of about 780 nm.

The objective lens 30 may condense the light emitted from the light source 11 to form an optical spot on the information storage medium 10.

The collimating lens 16 may collimate the first and second lights 51a and 55a emitted from the light source 11 to allow the first and second lights 51a and 55a to be incident onto the objective lens 30. For example, the collimating lens 16 may be disposed between the optical path changer and the objective lens 30.

The optical path changer 14 allows light that is incident from the light source 11 to proceed toward the objective lens 30 and allows light that is incident from the optical information storage medium 10 to proceed toward the photodetector 40. For example, the optical path changer 14 may be polarization dependent to change a path of incident light according to polarization, e.g., a polarizing beam splitter. A quarter wave plate 19 which changes polarization of incident light may be included on an optical path between the polarizing beam splitter and the objective lens 30. As an example, the quarter wave plate 19 is disposed between the polarizing beam splitter and the collimating lens 16 in FIGS. 1 and 2. As another example, the quarter wave plate 19 may be disposed between the collimating lens 16 and the objective lens 30.

When the polarizing beam splitter and the quarter wave plate 19 are included, one linearly polarized light incident from the light source 11 onto the polarizing beam splitter, e.g., p polarized light, may penetrate a mirror surface of the polarizing beam splitter, may pass through the quarter wave plate 19 to be changed as one circularly polarized light, and may proceed toward the optical information storage medium 10. The one circularly polarized light may be reflected from the optical information storage medium 10 as other circularly polarized light and may pass through the quarter wave plate 10 again. The other linearly polarized light may be reflected from the mirror surface of the polarizing beam splitter and may proceed toward the photodetector 40.

For example, the polarization dependent optical path changer may be a polarization hologram device which transmits one polarized light emitted from the light source 11 and diffracts other polarized light reflected from the optical information storage medium 10 in +1^{th} order or −1^{th} order. In an example in which the polarization dependent optical path changer is the polarization hologram device, the light source 11 and the photodetector 40 may be packaged into an optical module.

An another example, instead of the polarization dependent optical path changer, the optical pickup 1 may include a beam splitter which transmits and reflects incident light in a predetermined ratio or a hologram device which transmits light emitted from the light source 11 and diffracts light reflected and incident from the optical information storage medium 10 in +1th or −1th order. In an example, in which the optical path changer is a hologram device, the light source 11 and the photodetector 40 may be packaged into an optical module.

The optical pickup 1 may further include a grating 12 which splits a light beam emitted from the light source into a 0^{th}-order light beam (a main light beam) and a 1^{th}-order light beam (a sub light beam) to detect a tracking error signal through a three beam method or a differential push-pull method. A reproducing signal may be obtained from a detection signal of the 0^{th}-order light beam reflected from the information storage medium 10. A tracking error signal may be obtained through an arithmetic operation of detection signals of the 0^{th}-order and 1^{th}-order light beams reflected from the optical information storage medium 10. Reference numeral 18 in FIGS. 1 and 2 denotes a reflective mirror which reflects an optical path.

The detecting lens 15 allows light that is reflected from the optical information storage medium 10 and that is incident through the objective lens 30, the collimating lens 16, and the like, to be formed as an optical spot on the photodetector 40. For example, the detecting lens 15 may include an astigmatic lens which generates an astigmatism to detect a focus error signal through an astigmatic method.

As another example, the detecting lens 15 may be formed to enlarge a light-receiving magnification. For example, the detecting lens 15 may include one lens surface which is a cylinder surface and other lens surface which is a spherical surface. Reflected light may be incident on the cylinder surface. Here, at least one lens surface of the detecting lens 15 may be formed in a structure in which a cylinder surface and a spherical surface are combined.

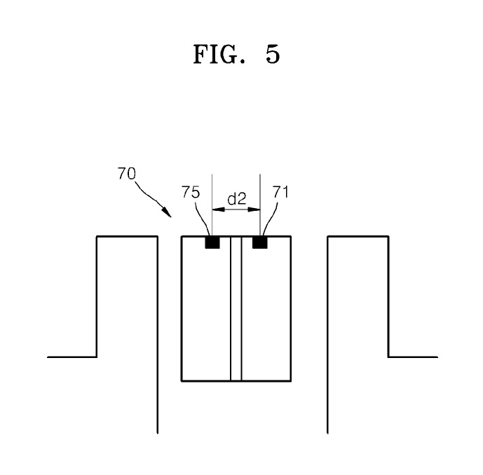

FIG. 4 illustrates an example of arrangements of first and second light-receiving patterns of a photodetector.

Referring to FIG. 4, the photodetector 40 includes a first light-receiving pattern 41 for receiving the first light 51a and a second light-receiving pattern 45 for receiving the second light 55a. For example, the photodetector 40 may be formed such that a minimum distance d between the first and second light-receiving patterns 41 and 45 is about 5 μm, through an enlargement of magnification performed by the detecting lens 15. In FIG. 4, the first and second light-receiving patterns 41 and 45 include main light-receiving parts (41a and 45a) and sub light-receiving parts (41b and 41c, and 45a and 45c) to detect a tracking error signal through a three beam method or a differential push-pull method. Splitting structures of the sub light-receiving parts 41b, 41c, and 45a, and 45c may be quadrant splitting structures and may be variously changed in consideration of a method of detecting a tracking error signal.

According to various aspects, the detective lens 15 may expand the magnification performed by the detecting lens 15. Accordingly, even if a gap between light-emitting points of the first and second light sources 51 and 55 is lower than the conventional 110 μm, a gap between the first and second light-receiving patterns 41 and 45 of the photodetector 40 may be maintained wider than or equal to 5 μm.

Accordingly, the shrink-type TWIN-LD 50 in which the gap between the first and second light sources 51 and 55 is narrower than or equal to 110 μm may be employed as the light source 11 of the optical pickup according to various aspects.

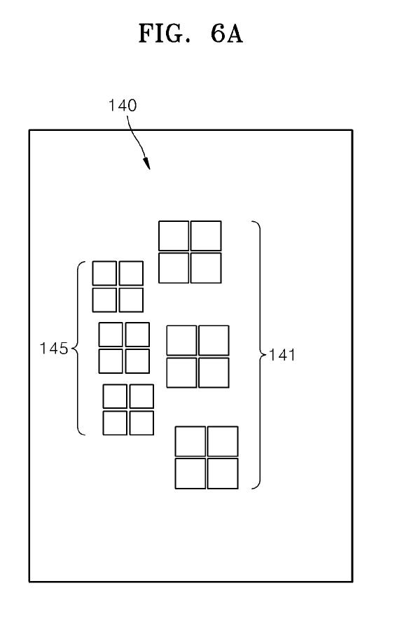

FIG. 5 illustrates an example of a general twin light source 70 as a comparison example of the shrink type TWIN-LS 50 employed as the light source 11 of the optical pickup 1. In FIG. 5, d2 represents a distance between light-emitting points of two light sources 71 and 75 of the general twin light source 70. In FIG. 3, d1 represent the distance between the light-emitting points of the first and second light sources 51 and 55 of the shrink type TWIN-LD 50. In these examples, the distance d1 between the two light-emitting points of the shrink type TWIN-LD 50 is narrower than the distance d2 between the two light-emitting points of the general twin light source 70.

For example, if the distance d2 of the general twin light source 70 is about 110 μm, the distance d1 of the shrink type twin light source 50 employed as the light source 11 may be a value lower than 110 μm, for example, about 90 μm.

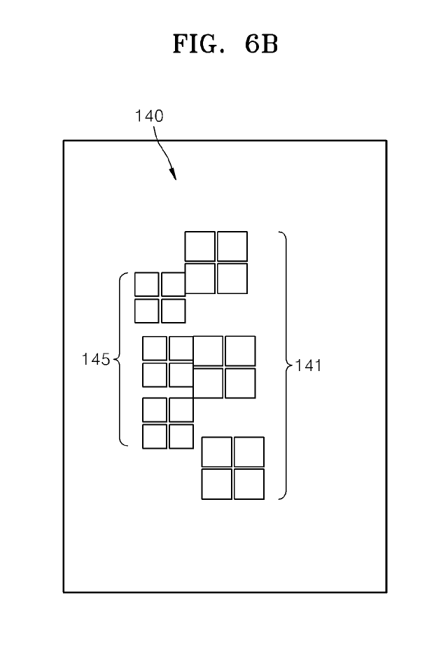

When the shrink-type twin light source 50 is employed in a general optical pickup without a change of a light-receiving magnification, as illustrated through a comparison between FIGS. 6A and 6B, first and second light-receiving patterns 141 and 145 of a photodetector 140 for receiving the first and second lights 51a and 55a will overlap with each other along the same axis.

Referring to FIGS. 6A and 6B, first and second light-receiving patterns of the photodetector 140 are drawn from a viewpoint of an optical spot received by the photodetector 40 to receive first and second lights emitted from a twin light source. FIG. 6A illustrates arrangements of the first and second light-receiving patterns 141 and 145 when a twin light source having a distance d2 of about 110 μm is employed in a general optical pickup. FIG. 6B illustrates the first and second light-receiving patterns 141 and 145 of the photodetector 140 when the shrink-type twin light source 50 is employed in a general optical pickup having the distance d2 of about 110 μm. FIGS. 6A and 6B illustrate the first and second light-receiving patterns 141 and 145 drawn from the viewpoint of the optical spot received by the photodetector 140 when conditions of the optical pickup are the same except for the difference between distances of two light-emitting points of the twin light sources 50 and 70.

As illustrated in the comparison example of FIGS. 6A and 6B, when a distance between two light-emitting points is about 110 μm, the first and second light-receiving patterns 141 and 145 keep an appropriate distance. However, when the distance between the two light-emitting points is about 90 μm, the first and second light-receiving patterns 141 and 145 overlap with each other. Accordingly, in order to employ the shrink-type twin light source 50, optical features of the optical pickup need to be adjusted.

Therefore, to enable the use of the shrink-type twin light source 50 in the optical pickup, a curvature radius of the detecting lens 15, a length of a light-receiving portion (A shown in FIG. 2), and the like, may be adjusted to adjust a light-receiving magnification. When a length of the light-receiving portion of the optical pick up is increased, the first and second light-receiving patterns 41 and 45 may be prevented from overlapping with each other.

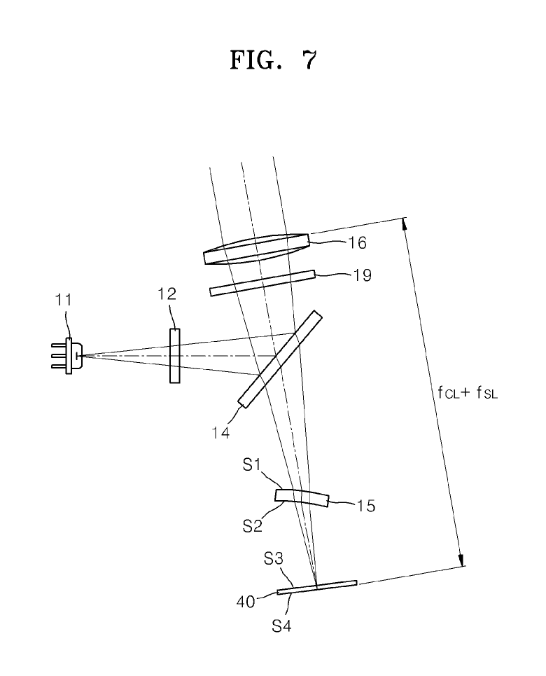

In the optical pickup 1, the light-receiving magnification may be determined so that a distance between the first and second light-receiving patterns 41 and 45 is at least 5 μm. According to various aspects, the length of the light-receiving portion (A shown in FIG. 2) of the optical pickup may increase by 5% or more in comparison with a length of an existing light-receiving portion. In this case, the light-receiving magnification may be 9.1 times or more to a minimum. An example of increasing the light-receiving portion of an optical pickup is illustrated in FIG. 7.

FIG. 7 illustrates an example of a focal distance (f_{CL}+f_{SL}) of a light-receiving portion. Referring to FIG. 7, f_{CL} denotes a focal point of the collimating lens 16, and f_{SL} denotes a focal distance of the detecting lens 15. The light-receiving magnification may be defined as (f_{CL}+f_{SL})/f_{OL}. In other words, the light-receiving magnification may be defined as a value obtained by dividing a sum (f_{CL+f}_{SL}) of the focal distance (f_{CL}) of the collimating lens 16 and the focal distance (f_{SL}) of the detecting lens 15 by a focal distance (f_{OL}) of the objective lens 30. Here, f_{OL} denotes the focal distance of the objective lens 30.

For example, when a focal distance (f_{OL}) of an objective lens is 1.54 mm as in a general optical pickup using the twin light source 70 in which a distance between two light-emitting points is about 110 μm, a light-receiving optical system may be designed so that a sum (f_{CL}+f_{SL}) of a focal distance (f_{CL}) of a collimating lens and a focal distance (f_{SL}) of a detecting lens is 12.82 mm, to determine a light-receiving magnification as 8.3 times (wherein 12.82/1.54=8.3). In this case, a gap between first and second light-receiving patterns of a photodetector may be maintained. That is, a conventional optical system may be designed so that a light-receiving magnification is about 8.3 times using the twin light source 70 in which the distance between the two light-emitting points is about 110 μm.

According to various aspects, when the shrink type twin light source 50 in which the distance between the two light-emitting points is about 90 μm, is employed, the light-receiving magnification needs to be enlarged to maintain the gap between the first and second light-receiving patterns 41 and 45 at an appropriate value.

The optical pickup according to various aspects may be formed to have an arrangement in which a light-receiving magnification is about 9.1 times or more. For example, when the focal distance (f_{OL}) of the objective lens 30 is about 1.54 mm (as in a general optical pickup), the light-receiving optical system, e.g., the cylinder surface and the spherical surface of the detecting lens 15, and the distance of the light-receiving part, etc. may be designed so that the sum (f_{CL}+f_{SL}) of the focal distance (f_{CL}) of the collimating lens 16 and the focal distance (f_{SL}) of the detecting lens 15 is about 14.03 mm. In this case, the light-receiving magnification may be about 9.1 times (wherein 14.03/1.54=9.1). When the light-receiving magnification is about 9.1 times and the shrink-type twin light source 50 is employed as the light source 11, the gap between the first and second light-receiving patterns 41 and 45 of the photodetector 40 may be secured as an appropriate value, e.g., about 5 μm or more.

Table 1 illustrates a comparison of a gap between first and second light-receiving patterns of a photodetector for appropriately receiving an optical spot if the shrink-type twin light source 50 is employed in the general optical pickup having the light-receiving magnification of 8.3 times and in the optical pickup 1 according to various aspects having the light-receiving magnification of about 9.1 times.

TABLE 1

| | General | Present exemplary |
|---|---|---|
| | Optical Pickup | embodiment |
| Light-receiving Magnification | 8.30 | 9.10 |
| Gap Between Light-receiving | −7.70 μm | 6.00 μm |
| Patterns | | |
| Shrink Type Twin Light Source | Unapplicable | Applicable |

As shown in Table 1, the gap between the first and second light-receiving patterns of the photodetector may be about 6.00 μm. Therefore, all of the first and second lights 51a and 55a emitted from the shrink-type twin light source 50 may be appropriately received.

Referring to the general optical pickup, the gap between the first and second light-receiving patterns is −7.7 μm, and thus the first and second light-receiving patterns overlap with each other. Therefore, the first and second lights 51a and 55a emitted from the shrink type twin light source 50 may not be appropriately received.

Table 2 illustrates examples of designs of the light-receiving optical system of the optical pickup in which the light-receiving magnification is about 9.1 times, i.e., designs of the detecting lens 15 and the photodetector 40. Table 3 illustrates examples of designs of a light-receiving optical system of the general optical pickup in which the light-receiving magnification is about 8.3, i.e. designs of the detecting lens 15 and the photodetector 40.

Referring to Tables 2 and 3, S1 denotes the cylinder surface of the detecting lens 15, S2 denotes the spherical surface of the detecting lens 15, S3 represents a light-receiving surface of a photodetector 40, and S4 represents a bottom surface of the photodetector 40. For the S2 in Tables 2 and 3, 8.603180, 8.178896 in a column of thickness/distance denotes a distance from a surface onto which light is incident from an optical path changer, e.g., an objective lens of a polarizing beam splitter to a photodetector.

TABLE 2

| | | Thickness/ |
|---|---|---|
| Surface | | Distance |
| No. | Curvature Radius [mm] | [mm] |
| S1 | CYL: −8.0 X-AXIS: INFINITY | 1.0 |
| | XDE: 0.340000 YDE: 0.000000 ZDE: 0.000000 | |
| | ADE: −1.850000 BDE: 17.000000 CDE: 31.000000 | |
| S2 | 7.0 | 8.603180 |
| | XDE: 0.265000 YDE: −0.010000 ZDE: 0.000000 | |
| | ADE: 0.000000 BDE: 0.000000 CDE: 0.000000 | |
| S3 | INFINITY | 0.3 |
| | XDE: 0.232106 YDE: −0.043324 ZDE: 0.000000 | |
| | ADE: 0.000000 BDE: 3.500000 CDE: 0.000000 | |
| S4 | INFINITY | 0.0 |

TABLE 3

| | | Thickness/ |
|---|---|---|
| Surface | | Distance |
| No. | Curvature Radius [mm] | [mm] |
| S1 | CYL: −7.0 X-AXIS: INFINITY | 1.0 |
| | XDE: 0.340360 YDE: 0.000000 ZDE: 0.000000 | |
| | ADE: −1.850000 BDE: 17.000000 CDE: 31.000000 | |
| S2 | 11.0 | 8.178896 |
| | XDE: 0.265000 YDE: −0.010000 ZDE: 0.000000 | |
| | ADE: 0.000000 BDE: 0.000000 CDE: 0.000000 | |
| S3 | INFINITY | 0.3 |
| | XDE: 0.237696 YDE: −0.028585 ZDE: 0.000000 | |
| | ADE: 0.000000 BDE: 3.500000 CDE: 0.000000 | |
| S4 | INFINITY | 0.0 |

In Tables 2 and 3, XDE denotes a coefficient of an x-axis direction, ADE denotes a rotation coefficient of the x-axis, YDE denotes a coefficient of a y-axis direction, BDE denotes a rotation coefficient of the y-axis, ZDE denotes a coefficient of a z-axis direction, and CDE denotes a rotation of the z-axis.

According to various aspects, the cylinder surface and the spherical surface of the detecting lens 15, the length of the light-receiving part, and the like, may be adjusted to set the light-receiving magnification to about 9.1 times or more. Therefore, the shrink-type twin light source 50 may be employed as the light source 11 and the distance between the first and second light-receiving patterns 41 and 45 of the photodetector 40 may be secured as at least 5 μm.

As described above, the optical pickup 1 includes the shrink-type twin light source 50 as the light source 11 to compatibly employ the DVD and the CD. It should also be appreciated that the optical pickup 1 may further include a light source which emits light having a blue wavelength for recording/reproducing a BD and an additional optical element.

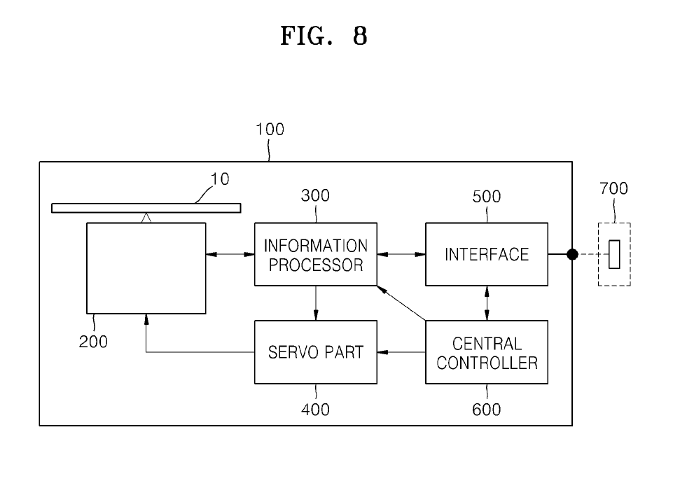

FIG. 8 illustrates an example of an optical system 100 including an optical pickup according to various aspects.

Referring to FIG. 8, the optical system 100 includes an optical pickup 200 which is installed to move in a radial direction of an information storage medium 10 to reproduce information from or record information to the information storage medium 10 and a controller 600 which controls the optical pickup 200.

The optical pickup 200 may include an optical pickup as described in the examples of FIGS. 1 through 7. The optical system also includes an encoder and/or a decoder and is connected to an information processor 300 connected to an interface 500 for a connection to an external host. The information processor 300 is also connected to a servo part 400. The information processor 300, the servo part 400, and the interface 500 are controlled by the controller 600, i.e. a central controller. The interface 500 may comply with various standards and may include a universal serial bus (USB) port. Therefore, the interface 500 may be connected to a host, e.g., a computer 700, according to a USB protocol to exchange information with the computer 700.

According to various aspects, a light-receiving magnification of an optical pickup may be adjusted to employ a shrink-type twin light source in which a distance between light-emitting points is narrowed as a light source. Even when the shrink-type twin light source is employed, light-receiving patterns of a photodetector do not overlap with each other.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical pickup comprising:
a light source which emits light;
an objective lens which condenses incident light to form an optical spot on an information storage medium;
a collimating lens which collimates the light emitted from the light source to allow the light to be incident onto the objective lens;
a photodetector which receives light reflected from the optical information storage medium to detect an information signal and/or an error signal; and
a detecting lens which forms the reflected light as an optical spot on the photodetector,
wherein the light source, the collimating lens, and the detecting lens are arranged such that the optical pickup has a light-receiving magnification of 9.1 times or more.

2. The optical pickup of claim 1, wherein the collimating lens is positioned between the objective lens and the light source.

3. The optical pickup of claim 1, wherein the light source comprises a twin light source that includes first and second light sources that emit first and second lights, respectively.

4. The optical pickup of claim 3, wherein a distance between light-emitting points of the first and second light sources is less than 110 μm.

5. The optical pickup of claim 3, wherein a distance between the light-emitting points of the first and second light sources is approximately 90 μm.

6. The optical pickup of claim 1, further comprising an optical path changer which changes an optical path of the incident light emitted from the light source.

7. The optical pickup of claim 1, wherein the light source comprises a twin light source, a distance between the two light-emitting points of the twin light source is less than 110 μm, and the detecting lens comprises a cylindrical surface and a spherical surface which are used to generate the light magnification of 9.1 times or more.

8. The optical pickup of claim 1, wherein the light source comprises a twin light source, a distance between the two light-emitting points of the twin light source is less than 110 μm, and a distance between the detecting lens and the collimating lens is used to generate the light magnification of 9.1 times or more.

9. The optical pickup of claim 1, wherein the light-receiving magnification is defined as a value that is obtained by dividing a sum of a focal distance of the collimating lens and a focal distance of the detecting lens divided by a focal distance of the objective lens.

10. The optical pickup of claim 1, wherein the photodetector comprises first and second light-receiving patterns which receive the first and second lights, respectively, and a distance between the first and second light-receiving patterns is at least 5 μm.

11. The optical pickup of claim 10, wherein the first light source emits a first light having a red wavelength for a digital versatile disc (DVD), and the second light source emits a second light having an infrared wavelength for a compact disc (CD).

12. An optical pickup comprising:
a twin light source comprising first and second light sources which emit first and second lights, respectively;
an objective lens which condenses incident light to form an optical spot on an information storage medium;
a collimating lens which collimates first and second lights emitted from the twin light source to allow the incident light onto the objective lens;
a photodetector which comprises first and second light-receiving patterns to receive first and second lights reflected from the information storage medium to detect an information signal and/or an error signal;
a detecting lens which forms the reflected first and second lights as an optical spot on the photodetector,
wherein a distance between light-emitting points of first and second light sources of the twin light source is shorter than 110 μm, and the detecting lens increases a light-receiving magnification in order to secure a gap between the first and second light-receiving patterns detecting the first and second lights of at least 5 μm.

13. The optical pickup of claim 12, wherein the distance between the light-emitting points of first and second light sources of the twin light source is approximately 90 μm.

14. The optical pickup of claim 12, wherein the first light source emits first light having a red wavelength for a DVD, and the second light source emits second light having an infrared wavelength for a CD.

15. The optical pickup of claim 13, further comprising an optical path changer which changes an optical path of the incident light emitted from the twin light source.

16. An optical information storage medium system comprising:
the optical pickup configured to move in a radial direction of an information storage medium to reproduce information from and/or record information to the information storage medium, the optical pickup comprising a twin light source, a collimating lens, and a detecting lens which are arranged such that the optical pickup has a light-receiving magnification of 9.1 times or more; and
a controller configured to control the optical pickup.

17. The optical information storage medium system of claim 16, wherein a distance between light-emitting points of the twin light source is less than 110 μm.

18. The optical information storage medium system of claim 16, wherein a distance between the light-emitting points of the twin light source is approximately 90 μm.

19. The optical information storage medium system of claim 16, wherein the photodetector comprises first and second light-receiving patterns which receive the first and second lights, respectively, and a distance between the first and second light-receiving patterns is at least 5 μm.
